(19) United States
(12) Patent Application Publication
(10) Pub. No.: US 2020/0348611 A1
(43) Pub. Date: Nov. 5, 2020

(54) HYDROPHOBIC SILICA POWDER, METHOD FOR PRODUCING SAME, AND TONER RESIN PARTICLES

(71) Applicant: FUSO CHEMICAL CO., LTD., Osaka-shi, Osaka (JP)

(72) Inventors: Hirokazu Yokota, Kawasaki-shi (JP); Munenori Komoto, Fukuchiyama-shi (JP); Kenichi Takeuchi, Fukuchiyama-shi (JP)

(73) Assignee: FUSO CHEMICAL CO., LTD., Osaka-shi, Osaka (JP)

(21) Appl. No.: 16/754,459

(22) PCT Filed: Sep. 21, 2018
(86) PCT No.: PCT/JP2018/035079

§ 371 Date: Apr. 8, 2020

(30) Foreign Application Priority Data
Oct. 17, 2017 (JP) 2017-201315

(51) Int. Cl. G03G 9/097; C09C 1/30

(52) U.S. Cl. CPC G03G 9/09725; C09C 1/3081; C01P 2004/62; C01P 2006/90; C01P 2004/64; C01P 2002/86

(57) ABSTRACT

A hydrophobic silica powder is disclosed that exhibits reduced desorption of a charge control agent, on the charge-controllable surface, and that is capable of imparting charge properties within a suitable range to toner resin particles to which the hydrophobic silica particles are externally added. A hydrophobic silica powder is characterized in that (1) the hydrophobic silica powder has a hydrophobicity of 50% or more; (2) an amount X is 0.1 mass % or more, the amount X being an amount of at least one compound selected from the group consisting of a quaternary ammonium ion, a mono-azo complex, and a mineral acid ion extracted with a mixture solvent of methanol and a ethanesulfonic acid aqueous solution: and (3) the amount X and an amount Y satisfy the following formula (I):

Y/X<0.15 (I),

the amount Y being an amount of the at least one compound extracted with water.

### TECHNICAL FIELD

The present invention relates to a hydrophobic powder, and toner resin particles.

### BACKGROUND ART

Inorganic-oxide fine particles have a variety of applications. In particular, silica particles are used as a main component or an additive component (e.g., an external additive) in a variety of fields, such as cosmetics, rubber, and abrasives, for the purpose of, for example, increasing strength and powder flowability, and imparting charge properties.

Silica externally added to toner particles may overly increase the charging level at low temperatures and low humidity, and may overly decrease the charging level at high temperatures and high humidity due to absorption of water. To control the charging level of the toner to which silica is externally added, there has been suggested a negatively chargeable toner for electrophotography that uses hydrophobic silica particles that have a hydrophobicity of 80% or more, and that have been treated with a quaternary ammonium salt compound or a polymer having a quaternary ammonium salt as a functional group (see, for example, PTL 1).

However, the hydrophobic silica particles disclosed in PTL 1 are fine hydrophobic silica particles that have been hydrophobized with a hydrophobizing agent, such as a silane coupling agent, beforehand (see paragraph [0010]). The surface of the fine hydrophobic silica particles is treated with, for example, quaternary ammonium salt compound (see paragraph [0012]). Thus, the quaternary ammonium salt on the charge-controllable surface of the hydrophobic silica particles disclosed in PTL 1 is easily desorbed. This causes the silica particles to clump, and makes it difficult for the particles to adhere to toner resin particles.

Additionally, depending on the application of toner resin particles, the charge properties are required to not be overly high, and must be adjusted to fall within a suitable range. Adjusting the charge properties of toner resin particles having silica particles externally added thereto so as to fall within a suitable range is not investigated in PTL 1.

Therefore, there is demand for the development of a hydrophobic silica powder that exhibits reduced desorption of a charge control agent, such as a quaternary ammonium salt, on the charge-controllable surface, and that is capable of imparting charge properties within a suitable range to toner resin particles to which the hydrophobic silica particles are externally added; and toner resin particles having the hydrophobic silica powder externally added thereto.

### CITATION LIST

### Patent Literature

PTL 1: JPH05-100471

### SUMMARY OF INVENTION

### Technical Problem

The present invention was made in view of the above-stated circumstances. An object of the invention is to provide hydrophobic silica powder that exhibits reduced desorption of a charge control agent, such as a quaternary ammonium salt, on charge-controllable surface, and that is capable of imparting charge properties within a suitable range to toner resin particles to which the hydrophobic silica particles are externally added; and toner resin particles having the hydrophobic silica powder externally added thereto.

### Solution to Problem

The present inventors conducted extensive research to achieve the object, and found that the object can be achieved by a hydrophobic silica powder characterized in that (1) the hydrophobic silica powder has a hydrophobicity of 50% or more; (2) an amount X is 0.1 mass % or more, the amount X being an amount of at least one compound selected from the group consisting of a quaternary ammonium ion, a mono-azo complex, and a mineral acid ion extracted with a mixture solvent of methanol and a methanesulfonic acid aqueous solution; and (3) the amount X and an amount Y of the at least one compound extracted with water satisfy the following formula (I):

Y/X<0.15 (I).

The inventors then completed the invention.

Specifically, the present invention relates to the following hydrophobic silica powders and toner resin particles.

1. A hydrophobic silica powder characterized in that
(1) the hydrophobic silica powder has a hydrophobicity of 50% or more,
(2) an amount X is 0.1 mass % or more, the amount X being an amount of at least one compound selected from the group consisting of a quaternary ammonium ion, a mono-azo complex, and a mineral acid ion extracted with a mixture solvent of methanol and a methanesulfonic acid aqueous solution, and
(3) the amount X and an amount Y satisfy the following formula (I):

Y/X<0.15 (I),

the amount Y being an amount of the at least one compound extracted with water.
2. The hydrophobic silica powder according to item 1, which bas a peak of M in a ²⁹Si-solid NMR spectrum.
3. The hydrophobic silica powder according to item 1 or 2, which has a hydrophobicity of 60% or more.
4. A method for producing hydrophobic silica powder comprising

adding at least one compound member selected from the group consisting of a quaternary ammonium ion, a mono-azo complex, and a mineral acid ion to an aqueous dispersion of silica particles, and

treating the aqueous dispersion with an organosilazane.

5. The method according to item 4, wherein secondary particles of the silica particles in the aqueous dispersion have a mean particle size of 5 to 200 nm.
6. The method according to item 4 or 5, wherein the organosilazane is hexamethyldisilazane.
7. A toner resin particle comprising a resin particle having the hydrophobic silica powder according to any one of items 1 to 3 externally added thereto.

### Advantageous Effects of Invention

The hydrophobic silica powder according to the present invention exhibits reduced desorption of a charge control agent, such as a quaternary ammonium salt, on the charge-controllable surface; and is capable of imparting charge properties within a suitable range to toner resin particles to which the hydrophobic silica particles are externally added. Due to the hydrophobic silica powder externally added thereto, the toner resin particle according to the present invention exhibits smaller decreases in hydrophobicity; and exhibits charge properties that are not overly high, and that are suitable for the intended use.

### DESCRIPTION OF EMBODIMENTS

Below, the hydrophobic silica powder and toner resin particle according to the present invention are described in detail.

### 1. Hydrophobic Silica Powder

The hydrophobic silica powder according to the present invention is characterized in that

(1) the hydrophobic silica powder has a hydrophobicity of 50% or more,
(2) an amount X is 0.1 mass % or more, the amount X being an amount of at least one compound selected from the group consisting of a quaternary ammonium ion, a mono-azo complex, and a mineral acid ion extracted with a mixture solvent of methanol and a methanesulfonic acid aqueous solution, and
(3) the amount X and an amount Y satisfy the following formula (I):

Y/X<0.15 (I),

the amount Y being an amount of the at least one compound extracted with water.

The hydrophobic silica powder that has the features described above according to the present invention exhibits an amount X of at least one compound selected from the group consisting of a quaternary ammonium ion, a mono-azo complex, and a mineral acid ion extracted with a mixture solvent of methanol and a methanesulfonic acid aqueous solution of 0.1 mass % or more. Thus, the hydrophobic silica powder has sufficient hydrophobic groups, and exhibits a hydrophobicity as high as 50% or more.

Additionally, because the amount X and the amount Y of the above-described compound extracted with water satisfy formula (I), the hydrophobic silica powder according to the present invention exhibits reduced desorption of a charge control agent having charge controllability, such as a quaternary ammonium salt, which is easily desorbed by water from the surface of hydrophobic silica particles. Below, the term “charge control agent” refers to at least one compound selected from the group consisting of a quaternary ammonium ion, a mono-azo complex, and a mineral acid ion.

Additionally, because the hydrophobic silica powder according to the present invention is hydrophobized by a specific group, which is extracted as at least one compound selected from the group consisting of a quaternary ammonium ion, a mono-azo complex, and a mineral acid ion, the hydrophobic silica powder exhibits a charging level that is not overly high and that is adjusted so as to fall within a suitable range, thus being capable of imparting charge properties within a suitable range to toner resin particles to which the hydrophobic silica particles are externally added.

The hydrophobicity of the hydrophobic silica powder is 50% or more. A hydrophobicity of less than 50% may result in a failure to impart sufficient charge properties to resin particles. The hydrophobicity is preferably 55% or more, and more preferably 60% or more. A higher hydrophobicity is better, and the upper limit is not particularly limited. The upper limit is preferably 100% or less, more preferably 98% or less, and still more preferably 95% or less.

In the present specification, the hydrophobicity is measured by the following method. Specifically, 50 mL of pure water is placed in a 200-ml, beaker; and 0.2 g of hydrophobic silica powder is added thereto, followed by stirring the mixture with a magnet stirrer, thereby preparing a dispersion of hydrophobic silica powder. The tip of a burette containing methanol is inserted into the dispersion, and methanol is added dropwise with stirring. The amount of methanol required to completely disperse the hydrophobic silica powder in water is measured, and determined to be A ml. The hydrophobicity then calculated using the following equation.

[hydrophobicity (%)]=[A/(50+A)]×100

In the hydrophobic silica powder, the amount X of at least one compound selected from the group consisting of a quaternary ammonium ion, a mono-azo complex, and a mineral acid ion extracted with a mixture solvent of methanol and a methahesulfonic acid aqueous solution is 0.1 mass % or more. An amount X that is less than 0.1 mass % indicates a smaller amount of the at least one compound added to the hydrophobic silica powder, and thus leads to an insufficient charge-reducing effect. The amount X is preferably 0.15 mass % or more, and more preferably 0.2 mass % or more. The upper limit of the amount X is not particularly limited, and is preferably about 5 mass %.

An example of the method for measuring the amount X is described below. Specifically, 10 parts by mass of a 2M methanesulfonic acid aqueous solution and 1 part by mass of a hydrophobic silica powder are added to 20 parts mass of methanol, and the mixture is subjected to ultrasonication for 30 minutes. Subsequently, 69 parts by mass of water is added, and the mixture is filtered through a 0.2-μm filter. Tetramethyl ammonium (TMA) ions are quantified by using ion chromatography (produced by Thermo Fisher Scientific), and the amount X based on 100 mass % of the hydrophobic silica powder is then measured.

In the hydrophobic silica powder, the amount Y of at least one compound selected from the group consisting of a quaternary ammonium ion, a mono-azo complex, and a mineral acid ion extracted with water is preferably 0.1 mass % or less, and more preferably 0.05 mass % or less. An amount Y within these numerical ranges leads the charge control agent to strongly bind to the surface of silica, thus reducing desorption of the charge control agent. The lower limit of the amount Y is not particularly limited, and is preferably about 0.005 mass %.

An example of the method for measuring the amount Y is described below. Specifically, 1 part by mass of a hydrophobic silica powder is added to 99 parts by mass of water, and the mixture is subjected to ultrasonication for 30 minutes. Subsequently, the mixture is filtered through a 0.2-μm filter. Tetramethyl ammonium (TMA) ions are quantified by using ion chromatography (produced by Thermo Fisher Scientific), and the amount Y based on 100 mass % of the hydrophobic silica powder is then measured.

In the hydrophobic silica powder, the amount X and the amount Y of at least one compound selected from the group consisting of a quaternary ammonium ion, a mono-azo complex, and a mineral acid ion (charge control agent) extracted with water satisfy the following formula (I):

Y/X<0.15 (I).

A Y/X ratio of 0.15 or more leads the quaternary ammonium salt and the like on the charge-controllable surface of the hydrophobic silica particles to easily desorb, thus decreasing stability. The Y/X ratio is preferably 0.15 or less, and more preferably 0.10 or less. The lower limit of Y/X not particularly limited, and is preferably about 0.001.

The secondary particles of the hydrophobic silica powder preferably have a volume average particle size (D50v) of 5 to 200 nm, more preferably 7 to 180 nm, and still more preferably 10 to 160 nm. A volume average particle size (D50v) of secondary particles within these numerical ranges enables the hydrophobic silica powder to impart more suitable charge properties to toner resin particles, when externally added to the toner resin particles.

The volume average particle size (D50v) of secondary particles can be determined as a 50% size (D50v) in cumulative frequency of an equivalent circle diameter obtained by an image analysis of secondary particles by, for example, observing 100 or more secondary particles in a hydrophobic silica powder with a scanning electron microscope (SEM JEOL Ltd.: JSM-6700) at 200,000-fold magnification.

The hydrophobic silica powder preferably has a peak derived from structure M in a ²⁹Si solid-state NMR spectrum. More specifically, the surface of the hydrophobic silica powder is preferably modified by a trimethylsilyl group that has structure M. Due to such a structure, the hydrophobic silica powder can have excellent hydrophobicity. This enables the hydrophobic silica powder to be externally added to toner particles uniformly.

The peak derived from structure M in a ²⁹Si solid-state NMR spectrum can be represented by peaks whose middle value in the chemical shift falls within the range of 15 to 10 ppm. The intensity of the peak derived from structure M is preferably present in an amount of 1% or more based on the total intensity of the peaks of structure Q2, structure Q3, and structure Q4.

In the present specification, the ²⁹Si-solid NMR spectrum is measured using a JNM-ECX400 (JEOL Ltd.) equipped with a 4-mm HXMAS probe under the following conditions: solid NMR sample tube: 4 mm, sample amount: 70 μL, nuclide for measurement: ²⁹Si (79.4 MHz), rotation frequency: 8 kHz, temperature: 21° C., measurement mode: CPMAX, repeating time: 3.10 sec, cumulated number: 2000 times, and external standard: silicon rubber (−22.333 ppm).

The hydrophobic silica powder according to the present invention preferably contains: 1) sodium, 2) an alkali earth metal selected from the group consisting of calcium and magnesium, and 3) a heavy metal selected from the group consisting of iron, titanium, nickel, chromium, copper, zinc, lead, silver, manganese, and cobalt, respectively in an amount of 1 ppm by mass or less. More preferably, the content of sodium, the content of an alkali earth metal, and the content of a heavy metal are each preferably 1 ppm by mass or less. In the present invention, the heavy metal refers to a metal element with a density of 4 g/cm³ or more. The content of an alkali earth metal and the content of a heavy metal each refer to the content of the individual metal element.

The hydrophobic silica powder according to the present invention preferably has a saturated water content of 3% or less, and more preferably 2% or less. An upper limit of the saturated water content within these numerical ranges leads the hydrophobic silica powder to impart more suitable charge properties to resin particles. The lower limit of the saturated water content is not particularly limited, and is about 0.01%.

### 2. Method for Producing Hydrophobic Silica Powder

The method for producing a hydrophobic silica powder according to the present invention includes adding at least one compound selected from the group consisting of a quaternary ammonium ion, a mono-azo complex, and a mineral acid ion to an aqueous dispersion of silica particles, and treating the aqueous dispersion with an organosilazane.

The secondary particles of the silica particles in the aqueous dispersion preferably have a mean particle size of 5 to 200 nm, more preferably 7 to 180 nm, and still more preferably 10 to 160 nm. A mean particle size of the secondary particles within these numerical ranges enables the silica particles to impart more suitable charge properties to toner resin particles, when externally added to the toner resin particles. The mean particle size of the secondary particles of the silica particles in an aqueous dispersion refers to a mean particle size of secondary particles as measured by dynamic light scattering.

The silica particles for use may be silica particles contained in commercially available colloidal silica. Examples of such commercially available products of colloidal silica include colloidal silica PL-1L, colloidal silica PL-2L, colloidal silica GP-6H, colloidal silica PL-7, and colloidal silica PL-10H (all manufactured by Fuso Chemical Co. Ltd.).

The aqueous dispersion of silica particles may be prepared by adding silica particles, such as of the colloidal silica described above, to water. The concentration of silica solids in the aqueous dispersion of silica particles is preferably 10 to 50 mass %, and more preferably 20 to 40 mass %, based on 100 mass % of the aqueous dispersion of silica particles.

In the production method according to the present invention, at least one compound selected from the group consisting of a quaternary ammonium ion, a mono-azo complex, and a mineral acid ion (charge control agent) is added to the aqueous dispersion of silica particles. From the standpoint of further increased charge controllability, the charge control agent is preferably quaternary ammonium ions, with tear methyl ammonium (TMA) ions being particularly preferable among them.

Salts that provide a quaternary ammonium ion include tetramethylammonium chloride, tetramethylammonium hydroxide, tetramethylammonium chloride, tetramethylammonium hydroxide, tetrabutylammonium chloride, tetrabutylammonium hydroxide, dodecyldimethylbenzylammonium chloride, octyltrimethylammonium chloride, decyltrimethylammonium chloride, dodecyltrimethylammonium chloride, tetradecyltrimethylammonium chloride, cetyltrimethylammonium chloride, stearyltrimethylammonium chloride, hexadecyltrimethylammonium bromide, benzyltrimethylammonium chloride, benzyltrimethylammonium chloride, benzalkonium chloride, benzalkonium bromide, benzethonium chloride, dialkyldimethylammonium chloride, didecyldimethylammonium chloride, and distearyldimethylammonium chloride. Of these, from the standpoint of providing a quaternary ammonium ion excellent in charge controllability, octyltrimethylammonium chloride, decyltrimethylammonium chloride, dodecyltimethylamonnium chloride, tetradecyltrimethylammonium chloride, cetyltrimethylammonium chloride, stearyltrimethylammonium chloride, alkyltrimethylammonium bromide, and hexadecyltrimethylammonium bromide are preferable.

The mono-azo complex includes a zinc complex of salicylic acid, and a boron complex of salicylic acid. Of these, from the standpoint of its capability of adding charge stability, a boron complex is preferable.

Salts that provide a mineral acid ion include nitric acid, hydrochloric acid, sulfuric acid, boric acid, salts of alkali metals th ereof, and salts of alkali earth metals thereof. Of these, from the standpoint of excellent charge controllability, nitric acid, hydrochloric acid, and sulfuric acid are preferable.

These compounds may be used singly, or in a combination of two or more.

The amount of the compound added is preferably 0.1 to 10 parts by mass, and more preferably 0.2 to 5 parts by mass, per 100 parts by mass of solids of silica particles. An amount of the compound added within these numerical ranges leads to further reduced desorption of the charge control agent, and leads resin particles to have more suitable charge properties.

The production method according to the present invention includes adding at least one compound selected from the group consisting of a quaternary ammonium ion, a mono-azo complex and nigrosin to an aqueous dispersion of silica particles, and treating the aqueous dispersion with an organosilazane.

The organosilazane includes hexamethyldisilazane; monosilanol compounds, such a trimethyl silanol, and triethyl silanol; monochlorosilanes, such as trimethylchlorosilane, and triethylchlorosilane; monoalkoxysilanes, such as trimethylmethoxysilane, and trimethylethoxysilane; mono-amino silanes, such as trimethylsilyl dimethylamine, and trimethylsilyl diethylamine; and monoacyloxysilanes, such as trimethyl acetoxysilane. Of these, from the standpoint of its capability of further reducing desorption of hydrophobic groups and imparting more suitable charge properties to resin particles, hexamethyldisilazane is preferable.

The amount of the organosilazane added is preferably 5 to 30 parts by mass, and more preferably 10 to 20 parts by mass, per 100 parts by mass of the solids of silica particles. An amount of the organosilazane added within these numerical ranges leads to further reduced desorption of hydrophobic groups, and enables resin particles to have more suitable charge properties.

In the production method according to the present invention, the organosilazane may not necessarily be added simultaneously with the at least one compound; however, it is preferred that the organosilazane be added simultaneously with the at least one compound. Adding the organosilazane simultaneously with the at least one compound leads to hydrophobic silica particles with high hydrophobicity, despite the low likeliness of desorption of the charge control agent from the surface.

The production method according the present invention includes adding the at least one compound selected from the group consisting of a quaternary ammonium ion, a mono-azo complex, and a mineral acid ion to the aqueous dispersion of silica particles, and treating the aqueous dispersion with the organosilazane. The treatment may be performed by preparing mixture as described above, by adding the at least one compound and the organosilazane to an aqueous dispersion of silica particles; and stirring the mixture by a known method.

The temperature of the mixture during stirring is not particularly limited, and is preferably 70 to 90° C., and more preferably 75 to 85° C.

The stirring time period is not particularly limited, and is preferably 100 to 300 minutes, and more preferably 160 to 200 minutes.

In this step, the pH of the mixture can be any pH; the pH is preferably 8 to 13, and more preferably 10 to 12.

The production method according to the present invention may produce a hydrophobic silica powder by further including a drying step and a pulverization step to form a powder after this step.

The drying method in the drying step can be any method, and drying may be performed by a known drying method. Examples of such a drying method include a method in which heating is performed with a dryer at a temperature of 100 to 130° C. for 180 to 480 minutes.

The pulverization method in the pulverization step can be any method, and pulverization may be performed with a known pulverization method. Examples of such a pulverization method include a jet mill.

### 3. Toner Resin Particles

The toner resin particles according to the present invention are those formed such that the hydrophobic silica powder is externally added to resin particles.

The resin particles for use in forming toner resin particles may be known resin particles used in toner resin particles. Examples of such resin particles include polyester resin particles, and vinyl resin particles. Of these, polyester resin particles are preferable.

The glass-transition temperature (Tg) of polyester resin is preferably 40° C. or higher, and 80° C. or lower. A glass-transition temperature within this numerical range makes it easier to maintain a low-fusing temperature.

The polyester resin preferably has a weight average molecular weight (Mw) of 5,000 or more, and 40,000 or less. The polyester resin also preferably has a number average molecular weight (Mn) of 2,000 or more, and 10,000 or less.

The method for externally adding a hydrophobic silica powder to resin particles can be any method, and a hydrophobic silica powder can be externally added by a known method. Examples of such a method include an external addition method using a “surface-modifying machine,” which is a typical powder mixer, such as a Henschel mixer, a V-blender, a Lödige mixer, and a hybridizer. The external addition may be performed such that a hydrophobic silica powder is adhered onto the surface of resin particles, or such that part of the hydrophobic silica powder is embedded in resin particles.

The volume average particle size (D50v) of the toner resin particles according to the present invention is preferably 2 μm or more, and 10 μm or less; and more preferably 4 μm or more, and 8 μm or less. A volume average particle size (D50v) of 2 μm or more leads to excellent flowability of the toner, and enables the carrier co impart suitable charger properties to the particles. A volume average particle size (D50v) of 10 μm or less results in a high-quality image.

The charge level of the toner resin particles according to the present invention is preferably 5 to 45 μC/g, and more preferably 8 to 40 μC/g. A charge level within these numerical ranges leads to further increased charge properties of the toner resin particles according to the present invention.

In the present specification, the charge level refers to a value determined by the following measurement method. Specifically, a hydrophobic silica powder is externally added to resin particles such that the ratio of the resin particles to the hydrophobic silica powder is 100:2 (mass ratio), thereby preparing toner resin particles. 10 g of the toner resin particles are weighed and placed in a 100-mL IBOY wide-mouth bottle (a plastic bottle with a volume of 100 mL), and subjected to pretreatment at 23° C. and 53% RH for 24 hours. Subsequently, the charge level is measured three times in a room adjusted to 20 to 25° C. and 50 to 60% RH with a suction-type Faraday cage (produced by Trek Japan, Model 212HS), and the average is determined as the charge level.

### EXAMPLES

Below, the present invention is described in more detail with reference to Examples. However, the present invention is not limited to these Examples.

### Preparation of Hydrophobic Silica Powder

### Example 1

10.4 parts by mass of a 25 wt % tetramethylammonium hydroxide (TMAH) aqueous solution (1.3 parts by mass per 100 parts by mass of silica solids), and 100 parts by mass of hexamethyldisilazane (HMDS) were added to 1000 parts by mass of colloidal silica PL-1L (produced by Fuso Chemical Co., Ltd., average primary particle size: 11 nm, secondary particle size: 18.6 nm, silica concentration: 20 wt %), and the mixture was reacted at 70 to 80° C. for 3 hours. Subsequently, the reaction mixture was dried 135° C. for 8 hours, hereby preparing a hydrophobic silica powder.

### Example 2

The procedure of Example 1 was repeated, except that colloidal silica PL-2L (produced by Fuso Chemical Co., Ltd., primary particle size: 23.7 nm, secondary particle size: 48.7 nm, silica concentration: 20 wt %) was used as colloidal silica; and that the amount of the 25 wt % TMAH aqueous solution was changed to 0.8 parts by mass (1 part by mass per 100 parts by mass of silica solids), thereby preparing a hydrophobic silica powder.

### Example 3

The procedure of Example 1 was repeated, except that colloidal silica GP-6H (produced by Fuso Chemical Co., Ltd., primary particle size: 61 nm, secondary particle size: 150 nm, silica concentration: 30 wt %) was used as colloidal silica; and that the amount of the 25 wt % TMAH aqueous solution was changed to 2 parts by mass (0.17 parts by mass per 100 parts by mass of silica solids), thereby preparing a hydrophobic silica powder.

### Example 4

The procedure of Example 1 was repeated, except that 25 parts by mass (3.8 parts by mass per 100 parts by mass of silica solids) of a 30 wt % dodecyltrimethylammonium chloride (DTMA-Cl) aqueous solution was used as a charge control agent, thereby preparing a hydrophobic silica powder.

### Example 5

The procedure of Example 1 was repeated, except that 6 parts by mass (0.9 parts by mass per 100 parts by mass of silica solids) of 30 wt % nitric acid aqueous solution was used as a charge control agent, thereby preparing a hydrophobic silica powder.

### Comparative Example 1

100 parts by mass of HMDS was added to 1000 parts by mass of colloidal silica PL-1L. The mixture was reacted at 70 to 80° C. for 3 hours. The reaction mixture was then dried at 135° C. for 8 hours, thereby preparing a hydrophobic silica powder. The silica content in the hydrophobic silica was 95 wt %.

Subsequently, 20 parts by mass of the prepared hydrophobic silica powder was added to 1000 parts by mass of methanol; and 1 part by mass of a 25% TMAH aqueous solution was further added thereto, followed by stirring for 1 hour. The mixture was dried at 120° C. for 3 hours, thereby preparing a hydrophobic silica powder treated with TMAH.

### Comparative Example 2

The procedure of Example 1 repeated, except that TMAH was not added, thereby preparing a hydrophobic silica powder.

### Comparative Example 3

The procedure of Comparative Example 1 was repeated, except that 0.6 parts by mass of 30% nitric acid was used as a charge control agent, thereby preparing a hydrophobic silica powder.

### Preparation of Toner Resin Particles

100 g of toner produced by Mikasa Sangyo Co., Ltd. (mean particle size: 9200 nm) was prepared as resin particles of polyester resin. These resin particles and 2 g of individual hydrophobic silica powder obtained in the Examples and Comparative Examples were placed in respective containers; and shaken with a shaker (produced by Yayoi Co., Ltd.; YS-8D) to externally add the hydrophobic silica powder to the resin particles, thereby preparing toner resin particles.

The properties of the hydrophobic silica powders obtained in the Examples and Comparative Examples were measured by the following methods.

### Amount X

### Examples 1 to 3 and Comparative Examples 1 and 2

10 parts by mass or a 2M methanesulfonic acid aqueous solution and 1 part by mass of a hydrophobic silica powder were added to 20 parts by mass of methanol, and the mixture was subjected to ultrasonication 30 minute. Subsequently, 69 parts by mass of water was added thereto, followed by filtration through a 0.2-μm filter. TMA ions were quantified by ion chromatography (produced by Thermo Fisher Scientific), and then the amount X based on 100 wt % of the hydrophobic silica powder was measured.

### Example 4

10 parts by mass of a 2M methanesulfonic acid aqueous solution, and 1 part by mass of a hydrophobic silica powder were added to 20 parts by mass of methanol, and the mixture was subjected to ultrasonication for 30 minutes. Subsequently, 69 parts by mass of water was added thereto, followed by filtration through a 0.2-μm filter. DTMA ions were quantified by ion chromatography (produced by Thermo Fisher Scientific), and then the amount X based on 100 wt % of the hydrophobic silica powder was measured.

### Example 5 and Comparative Example 3

10 parts by mass of a 2M methanesulfonic acid aqueous solution and 1 part by mass of a hydrophobic silica powder were added to 20 parts by mass of methanol, and the mixture was subjected to ultrasonication for 30 minutes. Subsequently, 69 parts by mass of water was added thereto, followed by filtration through a 0.2-μm filter. Nitrate ions were quantified by ion chromatography (Produced by Thermo Fisher Scientific), and then the amount X based on 100 wt % of the hydrophobic silica powder was measured.

### Amount Y

### Examples 1 to 3 and Comparative Examples 1 and 2

1 part by mass of a hydrophobic silica powder was added to 99 parts by mass of water, and the mixture was subjected to ultrasonication for 30 minutes. Subsequently, the mixture was filtered through a 0.2-μm filter. TMA ions were quantified by ion chromatography (produced by Thermo Fisher Scientific), and then the amount Y based on 100 wt % of the hydrophobic silica powder was measured.

### Example

1 part by mass of a hydrophobic silica powder was added 99 parts by mass of water, and the mixture was subjected to ultrasonication for 30 minutes. Subsequently, the mixture was filtered through a 0.2-μm filter. DTAM ions were quantified by ion chromatography (produced by Thermo Fisher Scientific), and then the amount Y based on 100 wt % of the hydrophobic silica powder was measured.

### Example 5 and Comparative Example 3

1 part by mass of a hydrophobic silica powder was added to 99 parts by mass of water, and the mixture was subjected to ultrasonication for 30 minutes. Subsequently, the mixture was filtered through a 0.2-μm filter. Nitrate ions were quantified by ion chromatography (produced by Thermo Fisher Scientific), and then the amount Y based on 100 wt % of the hydrophobic silica powder was measured.

### Hydrophobicity

50 mL of pure water was placed in a 200-mL beaker; and 0.2 g of a hydrophobic silica powder was added thereto, followed by stirring with a magnet stirrer, thereby preparing a dispersion of the hydrophobic silica powder. The tip of a burette containing methanol was inserted into the dispersion, and methanol was added dropwise with stirring. The amount of methanol required to completely disperse the hydrophobic silica powder in water was measured and determined as A mL. The hydrophobicity was then calculated using the following equation.

[Hydrophobicity (%)]=[A/(50+A)]×100

### ²⁹Si-Solid NMR Spectrum

The ²⁹Si-solid NMR spectrum of a hydrophobic silica powder was measured with a JNM-ECX400 (JEOL Ltd.) equipped with a 4-mm HXMAS probe under the following conditions: solid NMR sample tube: 4 mm, sample amount: 70 μL, nuclide for measurement: ²⁹ Si (79.4 MHz), rotation frequency: 8 kHz, temperature: 21° C., measurement mode: CPMAX, repeating time: 3.10 sec, cumulated number: 2000 times, external standard: silicon rubber (−22.333 ppm).

### Charging Level

A hydrophobic silica powder was externally added to resin particles such that the ratio of the resin particles to the hydrophobic silica powder becomes 100:2 (mass ratio), thereby preparing toner resin particles. 10 g of the toner resin particles were weighed and placed in a 100-mL IBOY wide-mouth bottle (a plastic bottle with a volume of 100 mL) and subjected to pretreatment at 23° C. and 53% RH for 24 hours. Subsequently, the charging level was measured three times in a room adjusted to 20 to 25° C. and 50 to 60% RH with a suction-type Faraday cage (produced by Trek Japan: Model 212HS), and the average was determined as the charging level.

Table 1 illustrates the results.

TABLE 1

| | Charge Control | | | | | | | | |
|---|---|---|---|---|---|---|---|---|---|
| | Agent (parts by | | Amount | Amount | | | | Charging | |
| | mass per 100 parts | | X | Y | | Hydrophobicity | | Level | External |
| | by mass of silica) | | (mass %) | (mass %) | Y/X | (%) | M Peak | (μC/g) | Addition |
| Ex. 1 | TMAH | 1.3 | 1.1 | 0.05 | 0.045 | 68 | Present | 17.4 | Possible |
| Ex. 2 | TMAH | 0.17 | 0.13 | 0.01 | 0.077 | 63 | Present | 32.3 | Possible |
| Ex. 3 | TMAH | 0.33 | 0.22 | 0.02 | 0.091 | 69 | Present | 12.3 | Possible |
| Ex. 4 | DTMA-Cl | 3.8 | 2.1 | 0.22 | 0.10 | 60 | Present | 10.6 | Possible |
| Ex. 5 | Nitric Acid | 0.9 | 0.55 | 0.04 | 0.072 | 62 | Present | 14.6 | Possible |
| Com. | TMAH | 1.3 | 1.2 | 0.20 | 0.17 | 0 | Present | — | Impossible |
| Ex. 1 | | | | | | | | | |
| Com. | — | 0 | 0 | 0 | 0 | 73 | Present | 48.7 | Possible |
| Ex. 2 | | | | | | | | | |
| Comp. | Nitric | 0.9 | 0.85 | 0.21 | 0.25 | 0 | Present | — | Impossible |
| Ex. 3 | Acid | | | | | | | | |

(Note that “Ex.” denotes Example, and “Comp. Ex.” denotes Comparative Example.)

As seen in the results in Table 1, the hydrophobic silica powders of Examples 1 to 5 have a Y/X ratio of less than 0.15, which is calculated from the amount X for extraction with a mixture solvent of methanol and a methanesulfonic acid aqueous solution, and the amount Y for extraction with water; this indicates that the inside of the hydrophobic silica powders was hydrophobized. Thus, desorption of the charge control agents was decreased.

The hydrophobic silica powders of Comparative Examples 1 and 3 had a high Y value and a high Y/X ratio because these silica powders were prepared by adding HMDS to colloidal silica to allow them to react; and, after preparing a hydrophobic silica powder, treating the surface of the powder with TMAH or nitric acid. Thus, the charge control agents were prone to desorption.

Additionally, the hydrophobic silica powders of Comparative Examples 1 and 3 became clumped, and could not be pulverized due to their insufficient hydrophobicity. Thus, these silica powders could not be externally added to resin particles.

Due to the non-use of TMAH, the hydrophobic silica powder of Comparative Example 2 made the charging level of toner resin particles overly high, and could not impart charge properties within a suitable Lange to the toner resin particles.

1. A hydrophobic silica powder characterized in that
(1) the hydrophobic silica powder has a hydrophobicity of 50% or more,
(2) an amount X is 0.1 mass % or more, the amount X being an amount of at least one compound selected from the group consisting of a quaternary ammonium ion, a mono-azo complex, and a mineral acid ion extracted with a mixture solvent of methanol and a methanesulfonic acid aqueous solution, and
(3) the amount X and an amount Y satisfy the following formula (I):
Y/X<0.15 (I),
the amount Y being an amount of the at least one compound extracted with water.

2. The hydrophobic silica powder according to claim 1, which has a peak of M in a ²⁹Si-solid NMR spectrum.

3. The hydrophobic silica powder according to claim 1, which has a hydrophobicity of 60% or more.

4. A method for producing a hydrophobic silica powder comprising
adding at least one compound member selected from the group consisting of a quaternary ammonium ion, a mono-azo complex, and a mineral acid ion to an aqueous dispersion of silica particles, and
treating the aqueous dispersion with an organosilazane.

5. The method according to claim 4, wherein secondary particles of the silica particles in the aqueous dispersion have a mean particle size of 5 to 200 nm.

6. The method according to claim 4, wherein the organosilazane is hexamethyldisilazane.

7. A toner resin particle comprising, a resin particle having the hydrophobic silica powder according to claim 1 externally added thereto.

8. The hydrophobic silica powder according to claim 2, which has a hydrophobicity of 60% or more.

9. The method according to claim 5, wherein the organosilazane is hexamethyldisilazane.

10. A toner resin particle comprising a resin particle having the hydrophobic silica powder according to claim 2 externally added thereto.

11. A toner resin particle comprising a resin particle having the hydrophobic silica powder according to claim 3 externally added thereto.
